(19) United States
(12) Patent Application Publication
(10) Pub. No.: US 2015/0294413 A1
(43) Pub. Date: Oct. 15, 2015

(54) METHOD AND SYSTEM FOR ASSURING CURRENCY EXCHANGE RATES

(71) Applicant: MasterCard International Incorporated, Purchase, NY (US)

(72) Inventors: Steven Joel JONAS, Westport, CT (US); Ina GOLDBERG, New York, NY (US); Douglas Michael RAYMOND, New Canaan, CT (US); Austin KAUH, Wilton, CT (US); Cleveland Michael ELLISON, Montclair, NJ (US)

(73) Assignee: MasterCard International Incorporated, Purchase, NY (US)

(21) Appl. No.: 14/250,870

(22) Filed: Apr. 11, 2014

(51) Int. Cl. G06Q 40/04

(52) U.S. Cl. CPC G06Q 40/04

(57) ABSTRACT

A method for providing an assured currency exchange rate includes: storing, in an account database, an account profile, wherein the account profile includes data related to a payment account including at least an account identifier, a conversion rule, and a period of time; receiving, by a receiving device, an authorization request for a payment transaction, wherein the authorization request includes at least the account identifier, a transaction amount in a first currency, and a transaction time and/or date that is within the period of time; calculating, by a processing device, a new transaction amount in a second currency based on application of the conversion rule to the transaction amount in the first currency; updating, by the processing device, the authorization request to include the calculated new transaction amount in the second currency; and forwarding, by a transmitting device, the updated authorization request.

### FIELD

The present disclosure relates to the assuring of currency exchange rates, specifically the processing of transactions for consumers that have a set currency conversion rule or exchange rate for a predetermined period of time.

### BACKGROUND

When a consumer travels to a foreign country, they are often times required to conduct payment transactions in a currency of the foreign country, which may different from their local currency. As a result, consumers must often purchase the currency of the foreign country, or else use a payment method that enables the conversion of currency during the processing of a transaction in the currency of the foreign country, such as a suitable type of payment card. In rare instances, a merchant may be able to perform currency exchange at the point of sale itself. However, as currency exchange rates change often, a consumer may engage in a payment transaction without a clear determination as to the amount they will be charged in their local currency until well after the transaction has been completed. Furthermore, many merchants may not even be capable of providing currency exchange at a point of sale.

Thus, there is a perceived need for a technical solution to provide for the exchange of currency at the time of a payment transaction with an assured exchange rate that can provide peace of mind and consistency to a consumer conducting payment transactions involving a different currency.

### SUMMARY

The present disclosure provides a description of systems and methods for providing an assured currency exchange rate.

A method for providing an assured currency exchange rate includes: storing, in an account database, an account profile, wherein the account profile includes data related to a payment account including at least an account identifier, a conversion rule, and a period of time; receiving, by a receiving device, an authorization request for a payment transaction, wherein the authorization request includes at least the account identifier, a transaction amount in a first currency, and a transaction time and/or date that is within the period of time; calculating, by a processing device, a new transaction amount in a second currency based on application of the conversion rule to the transaction amount in the first currency; updating, by the processing device, the authorization request to include the calculated new transaction amount in the second currency; and forwarding, by a transmitting device, the updated authorization request.

A system for providing an assured currency exchange rate includes an account database, a receiving device, a processing device, and a transmitting device. The account database is configured to store an account profile, wherein the account profile includes data related to a payment account including at least an account identifier, a conversion rule, and a period of time. The receiving device is configured to receive an authorization request for a payment transaction, wherein the authorization request includes at least the account identifier, a transaction amount in a first currency, and a transaction time and/or date that is within the period of time. The processing device is configured to: calculate a new transaction amount in a second currency based on application of the conversion rule to the transaction amount in the first currency; and update the authorization request to include the calculated new transaction amount in the second currency. The transmitting device is configured to forward the updated authorization request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for providing an assured currency exchange rate in accordance with exemplary embodiments.

FIG. 2 is a block diagram illustrating the processing server of FIG. 1 for the providing of an assured currency exchange rate in accordance with exemplary embodiments.

FIG. 3 is a flow diagram illustrating a process for processing payment transactions using an assured currency exchange rate using the system of FIG. 1 in accordance with exemplary embodiments.

FIG. 4 is a flow diagram illustrating a process for providing an assured currency exchange rate using the processing device of FIG. 2 in accordance with exemplary embodiments.

FIG. 5 is a flow chart illustrating an exemplary method for providing an assured currency exchange rate in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard ®, VISA®, Discover ®, American Express ®, PayPal , etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Providing Assured Currency Conversion Rates

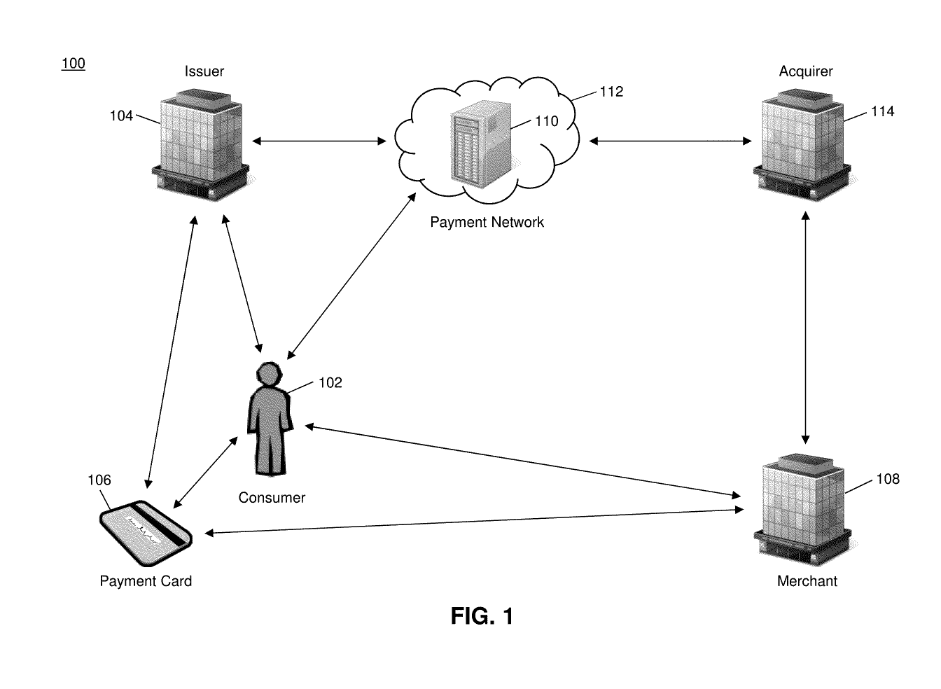

FIG. 1 illustrates a system 100 for the providing of assured currency exchange rates for a payment transaction conducted in one, local currency being converted into a second, preferred currency of a consumer.

The system 100 may include a consumer 102. The consumer 102 may have one or more payment accounts with an issuer 104. The issuer 104 may be any type of financial institution or entity suitable for performing the functions disclosed herein, such as an issuing bank. The payment account or accounts associated with the consumer 102 and held by the issuer 104 may use a preferred currency. The preferred currency may be based off of the geographic location of the consumer 102 or the issuer 104, and may be established at the time the corresponding payment account is open. In some instances, the consumer 102 may be able to change the preferred currency associated with the payment account.

The issuer 104 may issue one or more payment cards 106 to the consumer 102. Each payment card 106 may be associated with a payment account of the consumer 102 that is held by the issuer 104. The consumer 102 may use the payment card 106 to conduct payment transactions to be funded by the associated payment accounts in the preferred currency, using methods or systems that will be apparent to persons having skill in the relevant art.

The consumer 102 may be visiting a different country or otherwise anticipating the conducting of payment transactions with one or more merchants 108 that may utilize a local currency different from the preferred currency. Prior to the transactions with the merchants 108, the consumer 102 may register for an assured currency exchange rate. The consumer 102 may utilize a suitable type of consumer device to communicate with a processing server 110 to register for an assured currency exchange rate. The consumer device may be any type of consumer device suitable for performing the functions discussed herein, such as a desktop computer, laptop computer, notebook computer, tablet computer, smart phone, telephone, etc. In some instances, the consumer 102 may correspond with the processing server via traditional mail, a third party (e.g., a user of the processing server 110), or any other suitable method as will be apparent to persons having skill in the relevant art.

As discussed in more detail below, the consumer 102 may register an account with the processing server 110. The processing server 110, discussed in more detail below, may be a part of, or otherwise associated with, a payment network 112 configured to process payment transactions. The consumer 102 may register their account with the processing server 110 and request an assured currency exchange rate. The processing server 110 may provide the consumer 102 with an assured currency exchange rate, which may be included in a currency conversion rule and stored in the account registered by the consumer 102.

The assured currency conversion rule may include details regarding the assured currency exchange rate provided to the consumer 102, which may include at least the preferred currency of the consumer 102, the local currency that the consumer 102 may transact in at the merchant 108, and the assured currency exchange rate. The conversion rule and/or the account of the consumer 102 may also include a period of time during which the assured currency exchange rate will be applied to transactions conducted in the local currency. The period of time may be a predetermined time established by the processing server 110 and/or the payment network 112.

After the currency conversion rule is established, the consumer 102 may transact with the merchant 108 using the payment card 106 during the period of time. As part of the conducting of a payment transaction, the merchant 108 may transmit transaction data for the payment transaction to an acquirer 114, such as an acquiring bank or other suitable financial institution or entity. The transaction data may include payment details, such as payment details encoded in the payment card 106, and a transaction amount. The transaction amount may be represented in the local currency of the merchant 108. The acquirer 114 may generate an authorization request for the payment transaction including the received data and may submit the authorization request to the payment network 112 using methods and systems that will be apparent to persons having skill in the relevant art.

The processing server 110 of the payment network 112 may receive the authorization request and may identify the payment details included therein to identify that the payment transaction involves the registered consumer 102. The processing server 110 may then, as discussed in more detail below, apply the assured currency conversion rule to the payment transaction to convert the transaction amount represented in local currency to a transaction amount represented in the preferred currency of the consumer 102. The processing server 110 may update the authorization request based on the application of the rule, and may process the payment transaction for the transaction amount in the preferred currency using traditional methods and systems for processing payment transactions that will be apparent to persons having skill in the relevant art.

As part of the processing, the issuer 104 may receive a forwarded authorization request from the processing server 110, and may approve the payment transaction based the data included therein. The issuer 104 may submit an authorization response indicating the transaction approval to the processing server 110, which may then forward the authorization response to the acquirer 114. The acquirer 114 may transmit that the transaction was approved to the merchant 108, who may then finalize the transaction with the consumer 102, such as by providing transacted-for goods or services. The consumer 102 may later on receive a statement from the issuer 104 for their payment account, which may reflect the processing of the payment transaction in the consumer's 102 preferred currency using the assured currency conversion rate.

The currency exchange rate offered by the processing server 110 to the consumer 102 may be based on current exchange rates for the preferred currency and local currency, and may be further based on additional criteria that will be apparent to persons having skill in the relevant art. For instance, the currency exchange rate may be based on data associated with the consumer 102, such as demographic data, spending history, travel history, prior experience date, use potential, account status, etc. For example, a consumer 102 with a preferred payment account with the issuer 104 may receive a more favorable rate than a consumer without a preferred account, which may be provided to the consumer 102 as incentive to use a specific payment card 106 and/or payment account. In embodiments where the consumer 102 may be an entity, such as a business, the exchange rate and/or period of time may be further based on the entity. For instance, a business may be provided with a longer period of time than an individual consumer 102.

By providing the consumer 102 with an assured currency exchange rate, the processing server 110 may be able to process payment transactions for the consumer 102 such that the consumer 102 can always have knowledge of the amount they will be paying prior to a transaction and see cleared transactions in their preferred currencies without surprise as to the exchange rate used in the transaction. In addition, by converting the currency using the conversion rule at the time of the processing of the transaction, the processing server 110 may be able to process the conversion without modification to the systems of the issuer 104, acquirer 114, or merchant 108. As a result, the merchant 108 and acquirer 114 may be able to transact in their local currency without regard for the preferred currency of the consumer 102, and the consumer 102 may be free to use their payment card 106 at any merchant 108 using the local currency without concern for the merchant's ability to process transactions for which currency must be converted.

### Processing Server

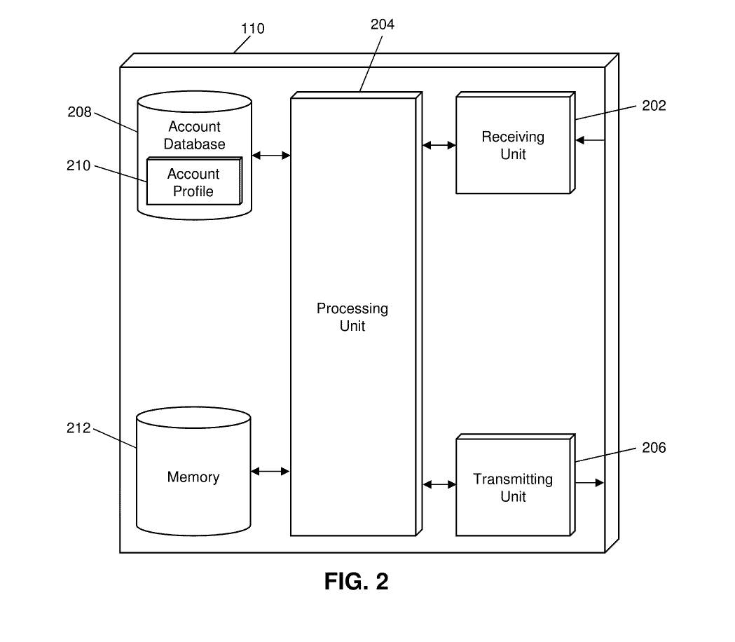

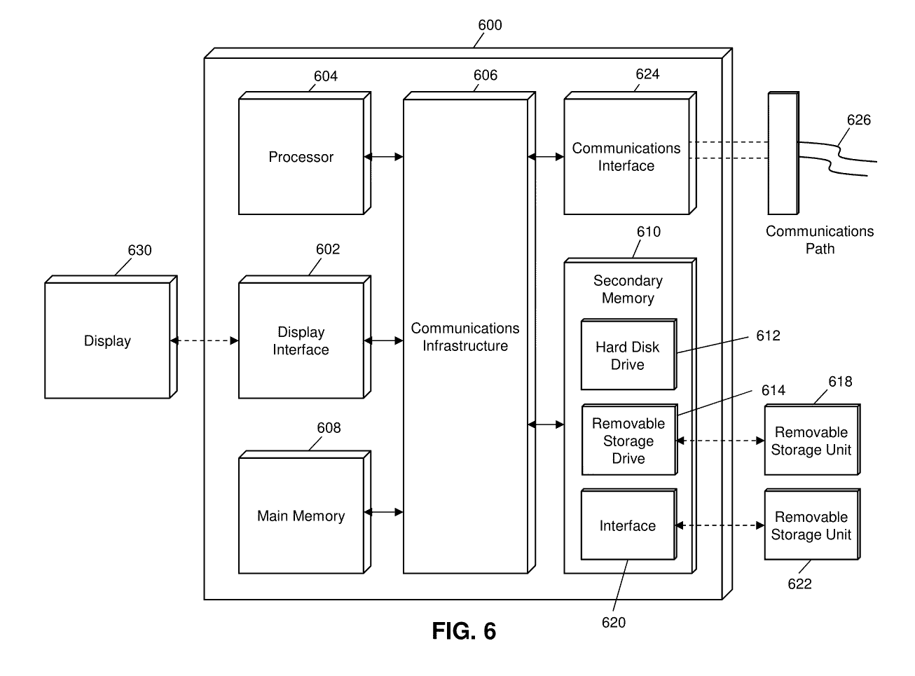

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of processing server 110 suitable for performing the functions as discussed herein. For example, the computer system 600 illustrated in FIG. 6 and discussed in more detail below may be a suitable configuration of the processing server 110.

The processing server 102 may include an account database 208. The account database 208 may be configured to store one or more account profiles 210. Each account profile 210 may include data related to a payment account (e.g., held by the issuer 104) including at least an account identifier, a conversion rule, and a period of time. The account identifier may be a unique value suitable for identification of the account profile 210 and/or related payment account, such as a payment account number, identification number, or other value as will be apparent to persons having skill in the relevant art.

The conversion rule may include at least the local currency, the preferred currency, and the exchange rate. In some embodiments, the conversion rule may include the period of time. The period of time may be a period during which the conversion rule is applied to payment transactions involving the related payment account. In some instances, the exchange rate included in the conversion rule may include a plurality of rates. For example, one rate may be applied to transactions within a specific transaction amount or range of transaction amounts, and a second rate may be applied to transactions outside of the specific transaction amount or range of transaction amounts. Different types of exchange rates and algorithms used for currency conversion will be apparent to persons having skill in the relevant art.

The processing server 110 may also include a receiving unit 202. The receiving unit 202 may be configured to receive data over one or more networks via one or more network protocols. The receiving unit 202 may receive data regarding application for an assured currency exchange rate from the consumer 102. The application may include an account identifier associated with a payment account of the consumer 102 (e.g., and associated with the payment card 106), the period of time, the local currency, and the preferred currency.

The processing server 110 may include a processing unit 204. The processing unit 204 may be configured to identify an exchange rate from the local currency to the preferred currency, such as based on market currency exchange rates, consumer data, and other data as will be apparent to persons having skill in the relevant art. The processing unit 204 may generate a currency conversion rule based on the identified exchange rate and the data received from the consumer 102. The processing unit 204 may store the generated currency conversion rule in an account profile 210 that includes the account identifier received from the consumer 102.

In some embodiments, the processing server 110 may provide the identified exchange rate to the consumer 102 prior to generating and storing the currency conversion rule. In such an embodiment, a transmitting unit 206 of the processing server 110, which may be configured to transmit data over one or more networks via one or more network protocols, may transmit the identified exchange rate to the consumer 102. The receiving unit 202 may then receive a confirmation from the consumer 102 indicating approval of the exchange rate. In a further embodiment, the consumer 102 may receive an estimated exchange rate prior to submitting the application for an assured currency exchange rate. In such an embodiment, the identified exchange rate may be transmitted to the consumer 102 to indicate the rate that will be provided to the consumer 102 after confirmation, such as a rate that may be affected by the consumer 102 (e.g., for preferred account status, etc.).

The receiving unit 202 may be further configured to receive authorization requests for payment transactions. Each authorization request may include at least an account identifier, a transaction amount in a local currency, and a transaction time and/or date. The processing unit 204 may be configured to identify an account profile 210 in the account database 208 including the account identifier included in an authorization request. The processing unit 204 may then determine if the payment transaction is conducted within the period of time included in the account profile 210, based on the transaction time and/or date included in the authorization request. In instances where the transaction time and/or date is outside of the period of time, the processing unit 204 may process the payment transaction using traditional methods, which may include business as usual (BAU) currency conversion from the local currency to the preferred currency. In instances where the transaction time and/or date is within the period of time, the processing unit 204 may apply the conversion rule included in the account profile 210 to the data included in the authorization request to convert the transaction amount in local currency to a transaction amount in preferred currency. The processing unit 204 may also update the transaction amount in the authorization request based on the application of the conversion rule.

The transmitting unit 206 may be configured to transmit the updated authorization request to the issuer 104. The receiving unit 202 may be configured to receive an authorization response from the issuer 104, which may be forwarded, by the transmitting unit 206, to the acquirer 114 in response to the earlier received authorization request.

The processing server 110 may also include a memory 212. The memory 212 may be configured to store data suitable for performing the functions disclosed herein, such as exchange rate data, consumer data, algorithms, program code, and other data as will be apparent to persons having skill in the relevant art. For instance, the memory 212 may include program code for an application program to be executed by the processing unit 204 to provide for an interface for the consumer 102 to apply for an assured currency exchange rate, such as accessed via a computing device of the consumer 102 or the payment network 112.

Process for Processing Payment Transactions with an Assured Conversion Rate

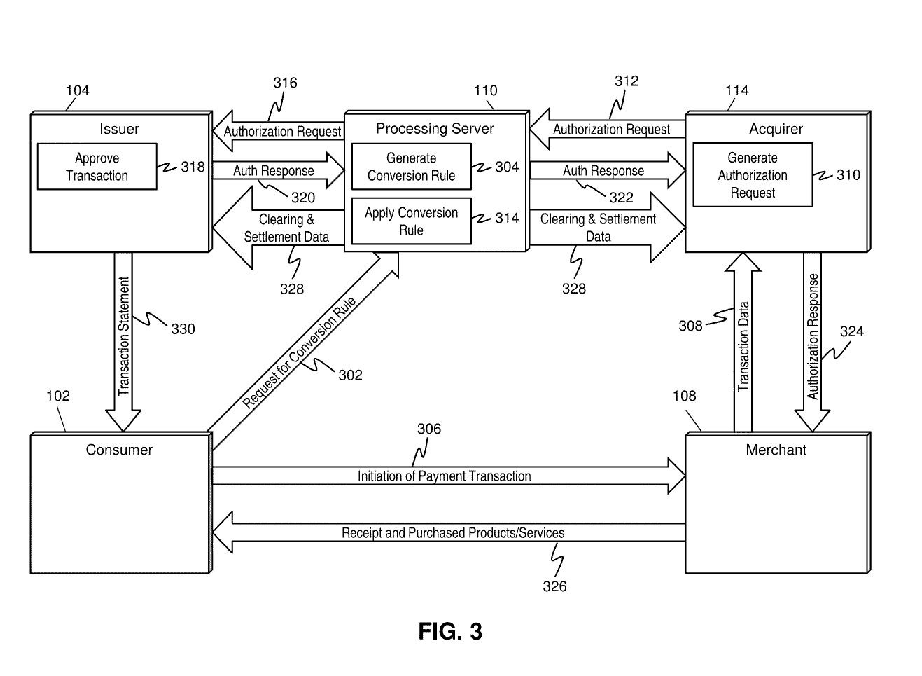

FIG. 3 illustrates a process for the processing of payment transactions using an assured exchange rate in the system 100 of FIG. 1.

In step 302, the consumer 102 may transmit a request for a conversion rule to the processing server 110 via a consumer device. The receiving unit 202 of the processing server 110 may receive the request for a conversion rule, which may include an account identifier, the preferred currency, the local currency, and the period of time. In step 304, the processing unit 204 of the processing server 110 may generate a conversion rule based on the received request, which may be stored in an account profile 210 in the account database 208 that includes the account identifier received in the request.

In step 306, the consumer 102 may initiate a payment transaction with the merchant 108 during the period of time. As part of the payment transaction, the consumer 102 may present the payment card 106 to a point of sale of the merchant 108. The point of sale may read payment details from the payment card 106, which may include the account identifier included in the request for conversion rule previously provided to the processing server 110. The point of sale of the merchant 108 may transmit transaction data to the acquirer 114, which may include at least a transaction amount in the local currency and the payment details read from the payment card 106.

In step 310, a computing system of the acquirer 114 may generate an authorization request for the payment transaction. The authorization request may include at least the transaction data received from the point of sale of the merchant 108. In step 312, the authorization request may be submitted by the system of the acquirer 114 to the processing server 110. The receiving unit 202 of the processing server 110 may receive the authorization request, and, in step 314, the processing unit 204 may apply the conversion rule to the received authorization request. Application of the conversion rule may include converting the transaction amount in the local currency to a transaction amount in the preferred currency using the previously identified exchange rate, and updating of the authorization request to also include the transaction amount in the preferred currency.

In step 316, the transmitting unit 206 of the processing server 110 may transmit the authorization request including the transaction amount in the preferred currency to the issuer 104. The issuer 104 may then, in step 318, approve the payment transaction based on the transaction amount in the preferred currency and a balance of the corresponding payment account and/or any other considerations as will be apparent to persons having skill in the relevant art. In step 320, the issuer 104 may provide an authorization response to the processing server 110 indicating approval of the payment transaction. The receiving unit 202 may receive the authorization response and, in step 322, the transmitting unit 206 may forward the authorization response on to the acquirer 114.

In step 324, the acquirer 114 may forward the authorization response to the merchant 108. In step 326, the merchant 108 may finalize the transaction by providing a receipt and the purchased products, goods, and/or services to the consumer 102. Following the finalization of the payment transaction, the payment network 112 may clear and settle the payment transaction using methods and systems that will be apparent to persons having skill in the relevant art. Clearing and settlement of the payment transaction may include the transmitting of clearing and settlement data from the transmitting unit 206 to the systems of the issuer 104 and acquirer 114, in step 328. In step 330, the issuer 104 may provide a transaction statement for the payment transaction to the consumer 102, which may indicate that the payment transaction was processed in the preferred currency for a transaction amount that is based on the exchange rate that was assured to the consumer 102, but may also include the transaction amount in the local currency.

### Process for Providing an Assured Currency Conversion Rate

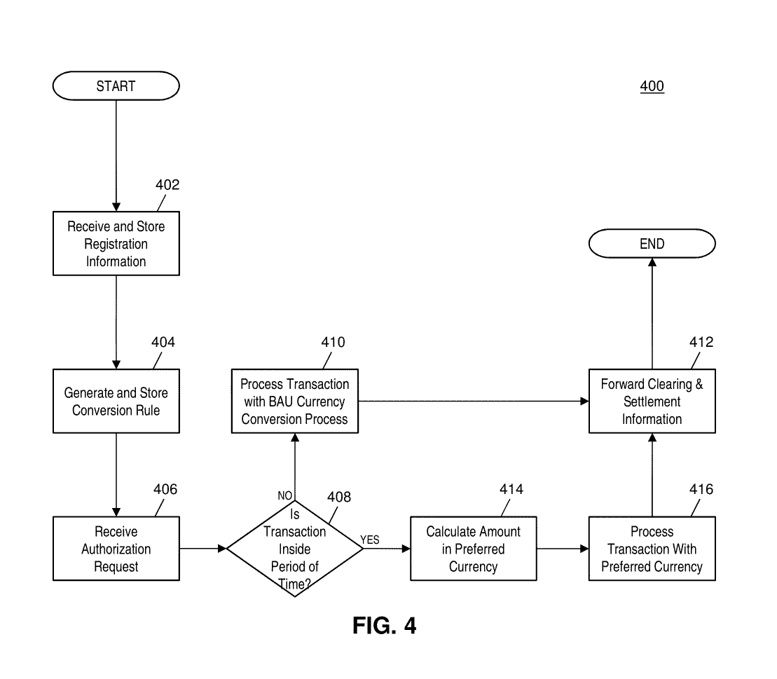

FIG. 4 illustrates a process 400 for the providing of an assured currency exchange rate as performed by the processing server 110.

In step 402, the receiving unit 202 of the processing server 110 may receive registration information from the consumer 102, which may include at least an account identifier, a local currency, a preferred currency, and a period of time. The processing unit 204 of the processing server 110 may generate an account profile 210 for storage in the account database 208 including at least the account identifier and period of time. In step 404, the processing unit 204 may generate a conversion rule based on at least the local currency and the preferred currency that includes an exchange rate for conversion from the local currency to the preferred currency, and may store the generated conversion rule in the previously generated and stored account profile 210.

In step 406, the receiving unit 202 of the processing server 110 may receive an authorization request for a payment transaction. The authorization request may include at least the account identifier, a transaction amount in the local currency, and a transaction time and/or date. In step 408, the processing unit 204 may determine if the transaction time and/or date is within the period of time included in the account profile 210.

If the transaction time and/or date is not within the period of time, then, in step 410, the processing unit 204 may process the payment transaction using a business-as-usual currency conversion process or other suitable method for processing the payment transaction from the local currency. Once the transaction is processed, then, in step 412, the transmitting unit 206 of the processing server 110 may forward clearing and settlement information when available to the issuer 104 and/or acquirer 114.

If the transaction time and/or date is determined to be within the period of time included in the account profile 210, then, in step 414, the processing unit 204 may apply the conversion rule to the authorization request to calculate a transaction amount in the preferred currency based on the exchange rate of the conversion rule and the transaction amount in the local currency included in the authorization request. In step 416, the processing unit 204 may process the payment transaction in the preferred currency using the calculated transaction amount using traditional methods and systems. The process 400 may then continue to step 412, where clearing and settlement information is forwarded to the issuer 104 and/or acquirer 114.

### Exemplary Method for Providing an Assured Currency Exchange Rate

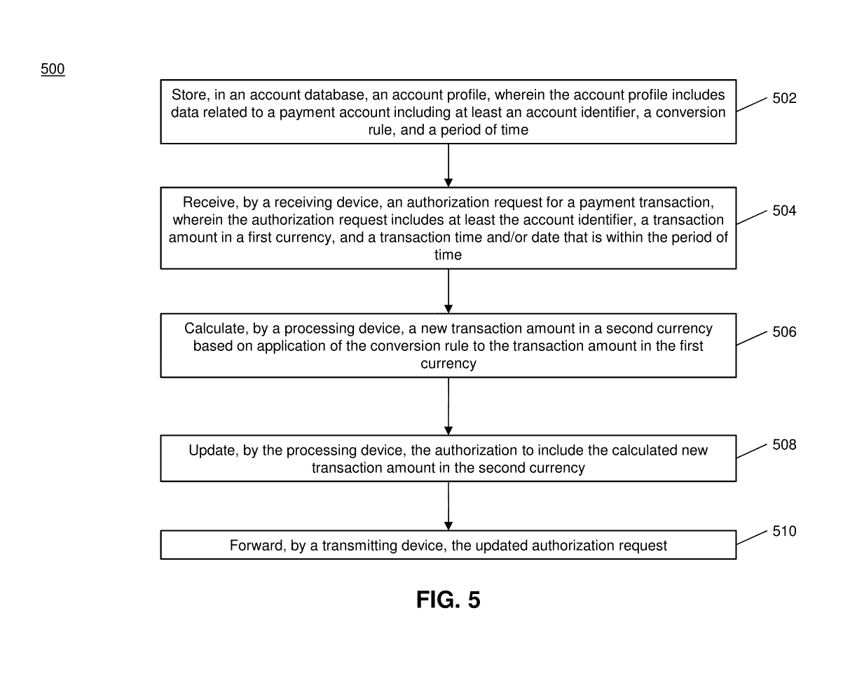

FIG. 5 illustrates a method 500 for providing an assured currency exchange rate for use in processing payment transactions in a preferred currency.

In step 502, an account profile (e.g., the account profile 210) may be stored in an account database (e.g., the account database 208), wherein the account profile 210 includes data related to a payment account including at least an account identifier, a conversion rule, and a period of time. In some embodiments, the account identifier may be a payment account number. In step 504, an authorization request for a payment transaction may be received by a receiving device (e.g., the receiving unit 202), wherein the authorization request includes at least the account identifier, a transaction amount in a first currency (e.g., a local currency), and a transaction time and/or date that is within the period of time.

In step 506, a new transaction amount in a second currency (e.g., a preferred currency) may be calculated, by a processing device (e.g., the processing unit 204), based on application of the conversion rule to the transaction amount in the first currency. In one embodiment, the conversion rule may include the first currency, the second currency, and an exchange rate. In a further embodiment, the exchange rate may be further based on at least one of: the period of time, an amount of time until the period of time, and consumer data associated with a consumer (e.g., the consumer 102) associated with the related payment account. In an even further embodiment, the consumer data may include at least one of: spending history, travel history, demographics, prior experiences, and use potential.

In step 508, the authorization request may be updated by the processing device 204 by including the calculated new transaction amount in the second currency. In step 510, the updated authorization request may be forwarded by a transmitting device (e.g., the transmitting unit 206).

In one embodiment, the method 500 may further include: receiving, by the receiving device 202, an authorization response as a response to the forwarded updated authorization request, and forwarding, by the transmitting device 206, the received authorization response in response to the received authorization request. In a further embodiment, the authorization response may include at least the calculated new transaction amount in the second currency.

In some embodiments, the method 500 may further include: receiving, by the receiving device 202, a conversion rule request, wherein the conversion rule request includes at least the account identifier, the period of time, the first currency, the second currency, and an exchange rate; and generating, by the processing device 204, the conversion rule based on at least the first currency, the second currency, and the exchange rate.

### Computer System Architecture

FIG. 6 illustrates a computer system 600 in which embodiments of the present disclosure, or portions thereof, may be implemented as computer-readable code. For example, the processing server 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for the providing of assured currency conversion rates. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing an assured currency exchange rate, comprising:
storing, in an account database, an account profile, wherein the account profile includes data related to a payment account including at least an account identifier, a conversion rule, and a period of time;
receiving, by a receiving device, an authorization request for a payment transaction, wherein the authorization request includes at least the account identifier, a transaction amount in a first currency, and a transaction time and/or date that is within the period of time;
calculating, by a processing device, a new transaction amount in a second currency based on application of the conversion rule to the transaction amount in the first currency;
updating, by the processing device, the authorization request to include the calculated new transaction amount in the second currency; and
forwarding, by a transmitting device, the updated authorization request.

2. The method of claim 1, further comprising:
receiving, by the receiving device, an authorization response as a response to the forwarded updated authorization request; and
forwarding, by the transmitting device, the received authorization response in response to the received authorization request.

3. The method of claim 2, wherein the authorization response includes at least the calculated new transaction amount in the second currency.

4. The method of claim 1, further comprising:
receiving, by the receiving device, a conversion rule request, wherein the conversion rule request includes at least the account identifier, the period of time, the first currency, the second currency, and an exchange rate; and
generating, by the processing device, the conversion rule based on at least the first currency, the second currency, and the exchange rate.

5. The method of claim 1, wherein the conversion rule includes the first currency, the second currency, and an exchange rate.

6. The method of claim 5, wherein the exchange rate is further based on at least one of: the period of time, an amount of time until the period of time, and consumer data associated with a consumer associated with the related payment account.

7. The method of claim 6, wherein the consumer data includes at least one of: spending history, travel history, demographics, prior experiences, and use potential.

8. The method of claim 1, wherein the account identifier is a payment account number.

9. A system for providing an assured currency exchange rate, comprising:
an account database configured to store an account profile, wherein the account profile includes data related to a payment account including at least an account identifier, a conversion rule, and a period of time;
a receiving device configured to receive an authorization request for a payment transaction, wherein the authorization request includes at least the account identifier, a transaction amount in a first currency, and a transaction time and/or date that is within the period of time;
a processing device configured to
calculate a new transaction amount in a second currency based on application of the conversion rule to the transaction amount in the first currency, and
update the authorization request to include the calculated new transaction amount in the second currency; and
a transmitting device configured to forward the updated authorization request.

10. The system of claim 9, wherein
the receiving device is further configured to receive an authorization response as a response to the forwarded updated authorization request,
the transmitting device is further configured to forward the received authorization response in response to the received authorization request.

11. The system of claim 9, wherein the authorization response includes at least the calculated new transaction amount in the second currency.

12. The system of claim 9, wherein
the receiving device is further configured to receive a conversion rule request, wherein the conversion rule request includes at least the account identifier, the period of time, the first currency, the second currency, and an exchange rate, and
the processing device is further configured to generate the conversion rule based on at least the first currency, the second currency, and the exchange rate.

13. The system of claim 9, wherein the conversion rule includes the first currency, the second currency, and an exchange rate.

14. The system of claim 13, wherein the exchange rate is further based on at least one of: the period of time, an amount of time until the period of time, and consumer data associated with a consumer associated with the related payment account.

15. The system of claim 14, wherein the consumer data includes at least one of: spending history, travel history, demographics, prior experiences, and use potential.

16. The system of claim 9, wherein the account identifier is a payment account number.
